(19) United States
(12) Patent Application Publication
(10) Pub. No.: US 2024/0317348 A1
(43) Pub. Date: Sep. 26, 2024

(54) SADDLE RIDING VEHICLE

(71) Applicant: HONDA MOTOR CO., LTD., Tokyo (JP)

(72) Inventors: Takashi Sato, Wako-shi (JP); Kazunori Maehara, Wako-shi (JP); Hisaki Sugaya, Wako-shi (JP); Takashi Saso, Wako-shi (JP); Tatsuya Asai, Wako-shi (JP); Masashi Saito, Wako-shi (JP); Yoshiharu Wada, Wako-shi (JP); Seiichi Kurohori, Wako-shi (JP)

(21) Appl. No.: 18/606,430

(22) Filed: Mar. 15, 2024

(30) Foreign Application Priority Data
Mar. 23, 2023 (JP) 2023-046905

(51) Int. Cl. B62J 27/20

(52) U.S. Cl. CPC B62J 27/20

(57) ABSTRACT

In a saddle riding vehicle including: a steering system that includes a handlebar; a meter that is arranged in front of the handlebar, and is disposed at a level lower than the handlebar; and an airbag apparatus that is disposed in the handlebar, the airbag apparatus includes: an inflator; an airbag that deploys with gas emitted by the inflator; and a retainer that houses the airbag, and the airbag includes a bulge portion that bulges toward the meter during deployment.

### INCORPORATION BY REFERENCE

The present application claims priority under 35 U.S.C. § 119 to Japanese Patent Application No. 2023-046905 filed on Mar. 23, 2023. The content of the application is incorporated herein by reference in its entirety.

### TECHNICAL FIELD

The present invention relates to a saddle riding vehicle.

### BACKGROUND ART

An airbag apparatus mounted in a saddle riding vehicle is conventionally known (see, e.g., Patent Literature 1). Patent literature 1 describes the configuration in which an airbag apparatus is disposed at a body frame between a steering system and a fuel tank, and a tether element extending from the fuel tank is connected to an airbag deployed. In Patent Literature 1, the tether element restrains the deployed airbag to adjust the posture of the airbag during deployment.

### CITATION LIST

### Patent Literature

[Patent Literature 1] JP-A No. H10-35564

### SUMMARY OF INVENTION

### Technical Problem

Now, there is a demand for the airbag apparatus to be disposed in the handlebar. However, it is difficult that the technology related to an airbag apparatus disposed at a body frame as described in Patent Literature 1 is applied to the posture control of an airbag apparatus disposed in a handlebar.

The present invention has been achieved in view of the above-mentioned circumstances, and it is an object thereof to provide a saddle riding vehicle capable of stabilizing the posture of an airbag during deployment in the saddle riding vehicle including an airbag apparatus in a handlebar.

### Solution to Problem

A saddle riding vehicle is provided with a steering system that includes a handlebar; a meter that is arranged in front of the handlebar, and is disposed at a level lower than the handlebar; and an airbag apparatus that is disposed in the handlebar. In the saddle riding vehicle, the airbag apparatus includes an inflator, an airbag that deploys with gas emitted by the inflator, and a retainer that houses the airbag. The airbag includes a bulge portion that bulges toward the meter during deployment.

### Advantageous Effects of Invention

In the saddle riding vehicle including the airbag apparatus in the handlebar, it is possible to provide the saddle riding vehicle easily stabilizing the posture of the airbag during deployment.

### BRIEF DESCRIPTION OF DRAWINGS

FIG. 1 is a side view of a saddle riding vehicle according to an embodiment of the present invention.

FIG. 2 is a view illustrating the periphery of a handlebar when the saddle riding vehicle is viewed from above and behind.

FIG. 3 is a sectional view taken along line III-III of FIG. 2.

FIG. 4 is a left side view illustrating a main section of the saddle riding vehicle with an airbag after deployment.

FIG. 5 is a view illustrating a main section of the saddle riding vehicle with the airbag after deployment as viewed from above and from the front side.

FIG. 6 is a perspective view of the airbag after deployment as viewed from the front and left.

FIG. 7 is a diagram illustrating a main section of the airbag.

FIG. 8 is an explanatory diagram when an occupant collides with the airbag after deployment.

### DESCRIPTION OF EMBODIMENTS

The following describes an embodiment of the present invention with reference to the drawings. Note that, in the description, descriptions on directions such as front and rear, right and left, and upper and lower are identical to directions with respect to a vehicle body insofar as descriptions are not particularly given. Reference sign FR illustrated in each drawing indicates a front side of the vehicle body, reference sign UP indicates an upper side of the vehicle body, and reference sign LH indicates a left side of the vehicle body.

### Embodiment

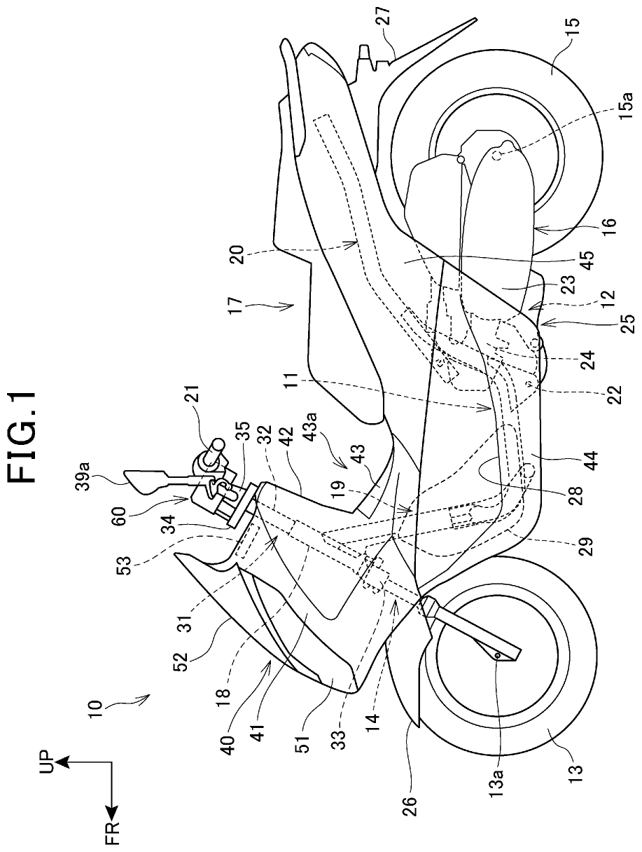

FIG. 1 is a side view of a saddle riding vehicle 10 according to the embodiment of the present invention.

The saddle riding vehicle 10 is a vehicle including a body frame 11, a power unit 12 supported by the body frame 11, a front fork 14 that steerably supports a front wheel 13, a swing arm 16 that supports a rear wheel 15, and a seat 17 for an occupant.

The saddle riding vehicle 10 is the vehicle on which the occupant straddles the seat 17 to ride. The seat 17 is disposed above a rear portion of the body frame 11.

The body frame 11 includes a head pipe 18 disposed at a front end portion of the body frame 11, a front frame 19 positioned at a rear of the head pipe 18, and a rear frame 20 positioned at a rear of the front frame 19. A front end portion of the front frame 19 is connected to the head pipe 18.

The seat 17 is supported by the rear frame 20.

The front fork 14 is supported by the head pipe 18 so as to be freely steerable in the right and left direction. The front wheel 13 is supported by an axle 13a disposed at a lower end portion of the front fork 14. A handlebar 21 for steering, which is gripped by the occupant, is mounted to an upper end portion of the front fork 14.

The swing arm 16 is supported by a pivot shaft 22 that is supported by the body frame 11. The pivot shaft 22 is a shaft that extends horizontally in a vehicle width direction. The pivot shaft 22 is inserted through a front end portion of the swing arm 16. The swing arm 16 swings in a vertical direction around the pivot shaft 22.

The rear wheel 15 is supported by an axle 15a disposed at a rear end portion of the swing arm 16.

The power unit 12 is arranged between the front wheel 13 and the rear wheel 15, and supported by the body frame 11.

The power unit 12 is an internal combustion engine. The power unit 12 includes a crankcase 23 and a cylinder portion 24 that houses a reciprocating piston. The cylinder portion 24 has an exhaust port to which an exhaust device 25 is connected.

An output from the power unit 12 is transmitted to the rear wheel 15 by a driving force transmitting member that connects the power unit 12 to the rear wheel 15.

The saddle riding vehicle 10 includes a front fender 26 that covers the front wheel 13 from above, a rear fender 27 that covers the rear wheel 15 from above, steps 28 on which the occupant places one's feet, and a fuel tank 29 to store fuel to be used by the power unit 12.

The front fender 26 is mounted to the front fork 14. The rear fender 27 and the steps 28 are disposed below the seat 17. The fuel tank 29 is supported by the body frame 11.

The saddle riding vehicle 10 according to the embodiment is a scooter type saddle riding vehicle including a seat 17 astride which an occupant is to sit. The power unit 12 of the saddle riding vehicle 10 is a unit swing engine that includes functions of an engine as a drive source for the rear wheel 15 and the swing arm 16 supporting the rear wheel 15. In the saddle riding vehicle 10, the steps 28 on which the rider places his/her right and left feet are step floors that are provided as a pair on the right and left below and in front of the seat 17.

The saddle riding vehicle 10 has a steering system 31 that includes a pair of right and left front forks 14. The steering system 31 has a steering shaft 32 pivotally supported by the head pipe 18. A bridge member 33 extending in a lateral direction is fixed to a lower end of the steering shaft 32. Upper portions of the pair of right and left front forks 14 are coupled to the right and left ends of the bridge member 33. The pair of right and left front forks 14 is arranged on the right and left sides of the front wheel 13 to support the front wheel 13.

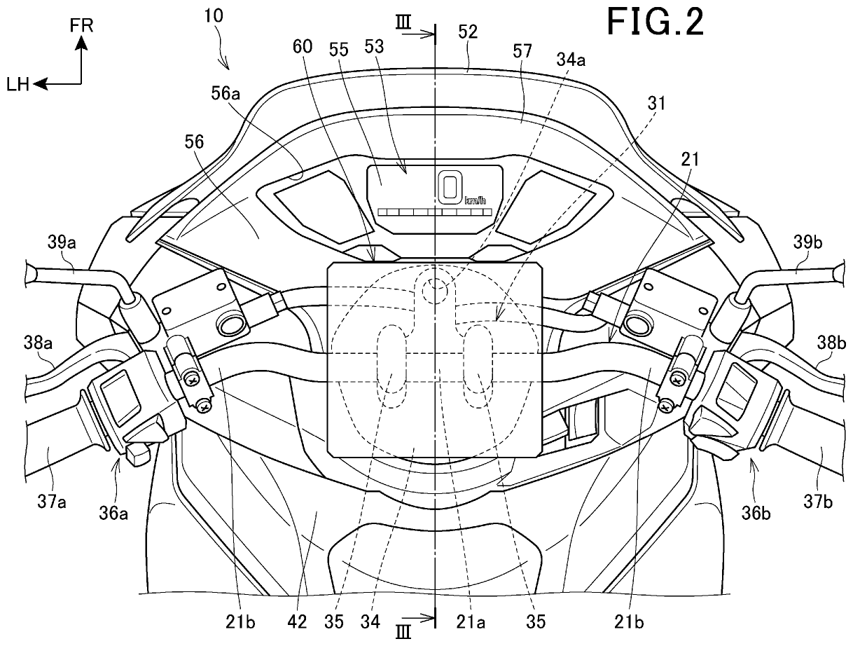

FIG. 2 is a view illustrating the periphery of the handlebar 21 when the saddle riding vehicle 10 is viewed from above and behind.

A plate-like handlebar post 34 is disposed at an upper end of the steering shaft 32. A pair of right and left handlebar holders 35 is disposed at the handlebar post 34. The handlebar 21 is fixed to the handlebar holders 35. The handlebar 21 includes a handlebar central portion 21a that is fixed to the handlebar holders 35 and extends in the lateral direction, and right and left extension portions 21b that extend from outer end in the lateral direction of the handlebar central portion 21a toward the outside in the lateral direction.

The steering system 31 in the embodiment is essentially made up of the steering shaft 32, the bridge member 33, the pair of right and left front forks 14, the handlebar post 34, the pair of right and left handlebar holders 35 and the handlebar 21.

Handlebar switches 36a, 36b are supported respectively by the right-left pair of right and left extension portions 21b. Grips 37a, 37b are disposed respectively on the right and left outer sides of the respective handlebar switches 36a, 36b. Also, each of handlebar levers 38a, 38b and each of rearview mirrors 39a, 39b are supported by corresponding one of the right-left pair of right and left extension portions 21b.

As illustrated in FIG. 1, FIG. 2, the saddle riding vehicle 10 includes a body cover 40 that covers the vehicle body including the body frame 11 and the like. The body cover 40 includes a front cover 41 that covers the head pipe 18 and an upper portion of the steering system 31 from the front and from the right and left sides, and an inner cover 42 that extends continuously from a rear edge of the front cover 41 to cover the head pipe 18 and an upper portion of the steering system 31 from the rear. The body cover 40 also includes a center cover 43 that is located below and in front of the seat 17, an undercover 44 that is located below the steps 28 to cover the vehicle body from below, and a rear side cover 45 that is located below the seat 17 to cover the rear frame 20 from the side.

A front portion of the center cover 43 extends continuously from a lower portion of the inner cover 42. The center cover 43 is located on the inner sides of the right and left legs of the rider, the legs extending from the seat 17 to the steps 28. As viewed from the side of the vehicle, the inner cover 42, the center cover 43 and a front face of the seat 17 define a straddling space 43a downwardly recessed. The occupant can straddle the saddle riding vehicle 10 via the straddling space 43a when he/she mounts/dismounts on/from the saddle riding vehicle 10.

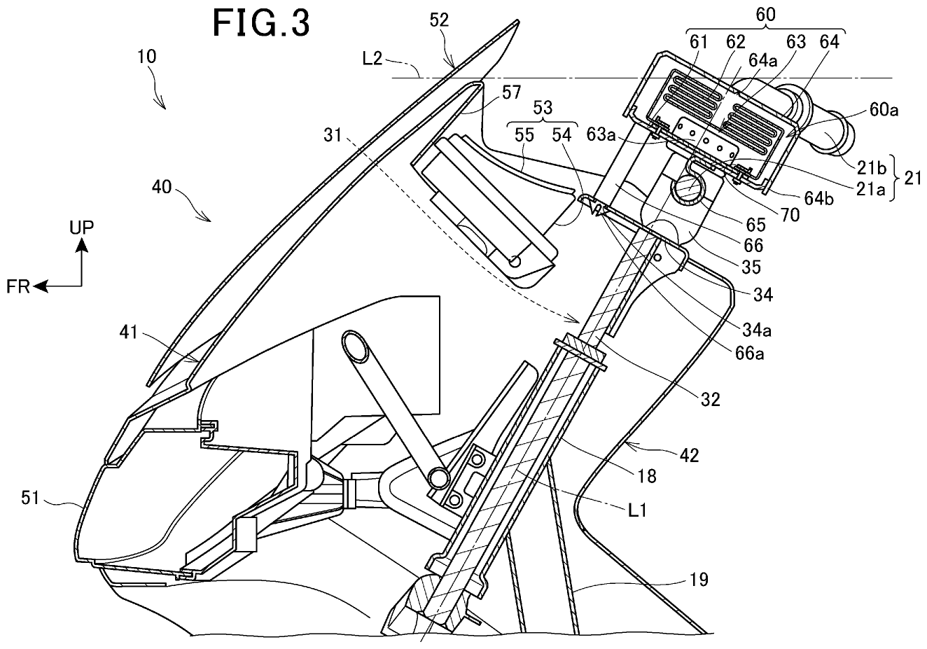

FIG. 3 is a sectional view taken along line III-III of FIG. 2.

A headlight 51 is disposed on a lower portion of a front face portion of the front cover 41. A windshield 52 is attached to an upper portion of the front face portion of the front cover 41. The windshield 52 is inclined upwardly toward the rear as viewed in the side of the vehicle. The windshield 52 is formed of materials having translucency such that the occupant can visually recognize an area ahead thereof through the windshield 52. A right-to-left width of the windshield 52 is smaller than a length between the left and right inner ends of the respective right and left grips 37a, 37b (see FIG. 2).

A meter 53 displaying information about the saddle riding vehicle 10 such as vehicle speed and/or the like is disposed at the rear of the windshield 52 and above the headlight 51. The meter 53 is arranged in front of the handlebar 21. The meter 53 is formed with a right-to-left width larger than a front-to-rear width as viewed from above (see FIG. 2). As viewed in the side of the vehicle body, the meter 53 is disposed below a handlebar upper end line L2 (see FIG. 3) which extends horizontally through an upper end of the handlebar 21.

The meter 53 includes a housing 54 that houses a meter main body, and a display screen 55 that is disposed on a top face of the housing 54. The housing 54 is formed in a flat box shape, and is arranged such that the through-thickness direction is oriented in a vertical direction. As viewed from above, the housing 54 is longer in the vehicle width direction. The meter 53 is arranged at the center in the vehicle width direction above the head pipe 18 and in front of the handlebar post 34. The meter 53 is arranged such that the display screen 55 on the top face is inclined downwardly toward the rear to make the meter 53 easily visible to the rider located above and at the rear of the meter 53. The meter 53 is fixed to the vehicle body, so that the meter 53 is not turned in the right and left directions even if the handlebar 21 is steered in the right and left directions.

The meter 53 is exposed forward through an opening 56a (see FIG. 2) of a meter cover 53 that extends in the lateral direction. The meter cover 56 is formed to be flush with the display screen 55. The meter cover 56 is disposed at the front cover 41. A canopy-shaped meter visor 57 is formed at a front end of the meter cover 56, and the meter visor 57 extends upwardly toward the rear in front of the meter 53. The meter visor 57 covers the meter 53 from above and front. The meter visor 57 corresponds to an upper portion of a front face portion of the front cover 41, and the upper portion extends further upward than the meter 53. The meter visor 57 is disposed such that light is blocked from reaching the top face of the meter 53 from above and front. The meter visor 57 is non-transparent, and has a lower translucency than that of the windshield 52. The meter visor 57 has a smaller right-to-left width than that of the windshield 52.

As illustrated in FIG. 2, FIG. 3, in the embodiment, an airbag apparatus 60 is supported at the handlebar 21. The airbag apparatus 60 is arranged in a central portion in the left-right direction of the handlebar 21. The airbag apparatus 60 in the embodiment is arranged to overlap the handlebar post 34 as viewed from the top. Stated another way, the airbag apparatus 60 is arranged on extension line L1 of the axis line of the steering shaft 32.

The airbag apparatus 60 includes a box-shaped retainer 61, an airbag 62 that is housed in the retainer 61, an inflator 63 that emits gas into the airbag 62, and a lid 64 that closes a top face of the retainer 61. A space surrounded by the retainer 61 and the lid 64 forms an airbag holding portion 60a.

The retainer 61 is formed in an approximately rectangular plate shape (see FIG. 2). The inflator 63 is supported on a top face of the retainer 61. The inflator 63 is fixed to the retainer 61 and arranged in a central portion in the vehicle width direction of the retainer 61. The inflator 63 includes a cylindrical housing 63a. A gas-forming agent, and an initiator that causes the gas-forming agent to induce a reaction producing gas are disposed within the housing 63a. The initiator includes an ignition device.

The airbag 62 is housed in the airbag holding portion 60a in folded condition as appropriate.

The lid 64 is attached to the retainer 61 by fitting an outer peripheral face thereof into a peripheral edge portion of the retainer 61. The lid 64 includes a cleavage portion 64a that cleaves when the airbag 62 deploys, and a fixed portion 64b that is fixed to an opening of the retainer 61 even after the airbag 62 has deployed.

A hook portion 65 that is hooked on the handlebar 21 is formed on the underside of the retainer 61. The hook portion 65 has a metal plate shape. The hook portion 65 is formed by being bent in an approximate S shape or in a curved shape in side view. The hook portion 65 is open forward. The handlebar 21 is inserted through the open portion into the hook portion 65 so that the hook portion 65 can be hooked on the handlebar 21. The hook portion 65 is arranged between the handlebar holders 35. The open part of the hook portion 65 is smaller in size than the diameter of the handlebar 21, for example. This may make it difficult for the handlebar 21 to remove from the hook portion 65 after the handlebar 21 is fitted into the hook portion 65 through the open portion.

Also, an insertion portion 66 extending downwardly is formed in front of the hook portion 65. A claw portion 66a is formed at the leading end (lower end) of the insertion portion 66. The claw portion 66a is inserted into an insertion hole 34a formed in a front end of the handlebar post 34. This causes the insertion portion 66 to be retained in the handlebar post 34.

The airbag apparatus 60 in the embodiment is mountable to the handlebar 21 by the simple configuration including the hook portion 65 and the insertion portion 66. Therefore, the airbag apparatus 60 is made easy to be attached. Also, instead of the configuration of the airbag apparatus 60 being attached to the handlebar 21 by use of the hook portion 65 and the insertion portion 66, the airbag apparatus 60 may be attached in the form of the retainer 61 being supported by the handlebar 21.

The saddle riding vehicle 10 includes an acceleration sensor (not shown) for sensing an impact acting on the saddle riding vehicle 10. The acceleration sensor is electrically connected to a controller (not shown) of the saddle riding vehicle 10, and the controller is electrically connected to the inflator 63. The controller is hardware including a processor, memory and/or the like. The controller determines based on a detected acceleration whether or not to actuate the airbag apparatus 60. If the airbag apparatus 60 is to be actuated, the controller actuates the inflator 63 to emit gas into the airbag 62. The airbag 62 expands with a gas pressure to deploy. Here, the controller may not be a controller for the vehicle itself, but may be an airbag controller. In other words, the controller may be an ECU (Electronic Control Unit) designed for the airbag 62, and the ECU may be independent of an ECU for vehicle control.

If the airbag apparatus 60 is to be actuated, the controller actuates the inflator 63 to emit gas into the airbag 62. The airbag 62 expands with a gas pressure so that the airbag 62 deploys outward from the retainer 61.

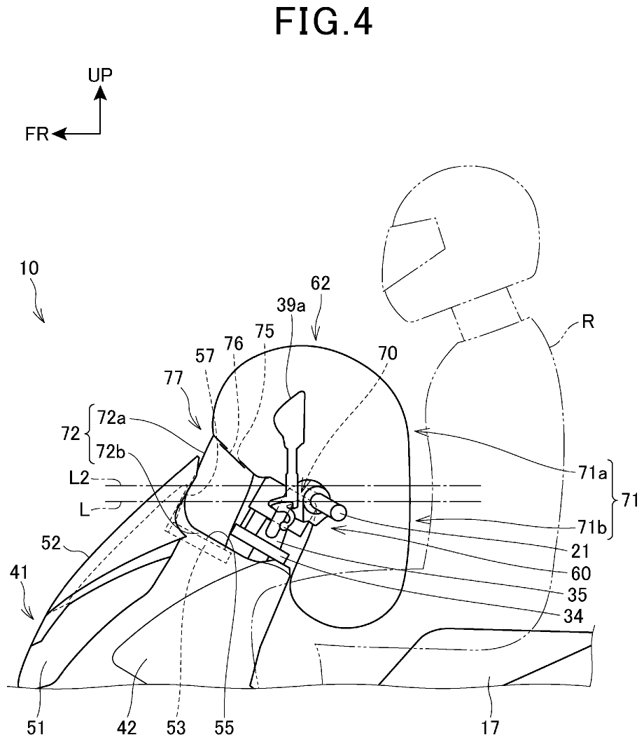

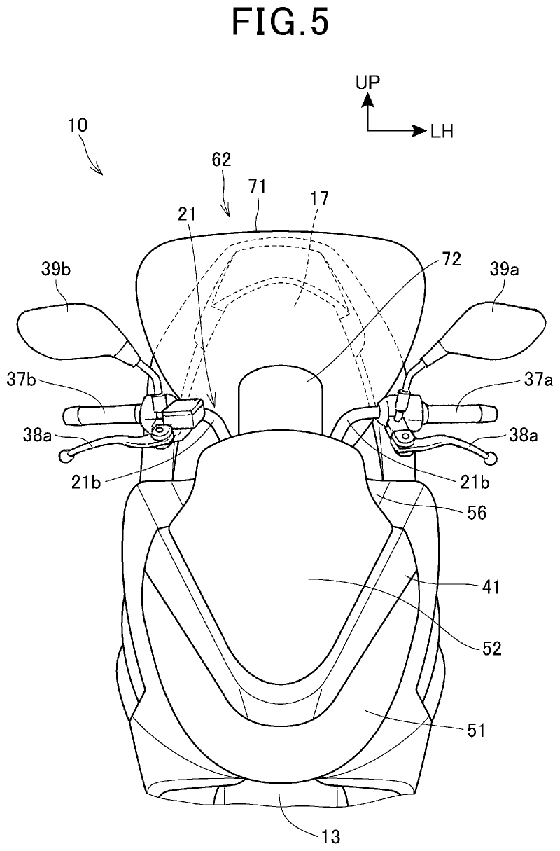

FIG. 4 is a left side view illustrating a main section of the saddle riding vehicle 10 with an airbag 62 after deployment. FIG. 5 is a view illustrating a main section of the saddle riding vehicle 10 with the airbag 62 after deployment as viewed from above and from the front side.

In the embodiment, the “during deployment” is referred to as a condition in which the inflator 63 is in the middle of operation and the airbag 62 is in the middle of expansion. Also, the “after deployment” is referred to as a condition in which the operation of the inflator 63 is terminated and the airbag 62 expands to a necessary and sufficient extent. Also, “the front face” for the airbag 62 is referred to as a portion seen after deployment as viewed from the front of the saddle riding vehicle 10. Further, “the rear face” for the airbag 62 is referred to as a portion seen after deployment as viewed from the rear.

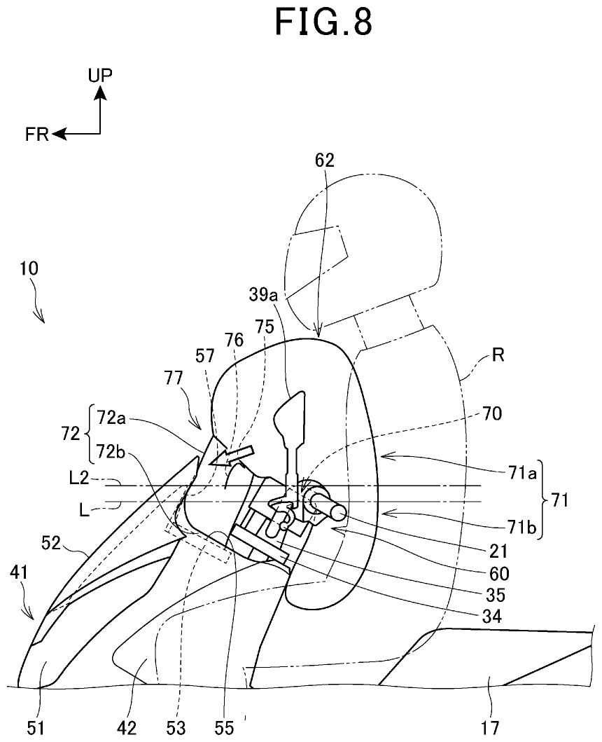

The airbag 62 is formed in a bag shape by stitching base fabric. The airbag 62 in the embodiment includes a bag-shaped main chamber (airbag main body) 71 that expands in front of an occupant R, and a tubular sub-chamber (bulge portion) 72 that is connected to the front face of the main chamber 71 and bulges forward the main chamber 71. The airbag 62 in the embodiment is configured to deploy rearward the handlebar 21 and also deploy upward and downward the handlebar 21. In FIG. 4, FIG. 8, a dash-dot line L is a horizontal line passing through a lower end of a connection portion 70 as viewed from the side of the vehicle body. In the embodiment, the dash-dot line L is located lower than the handlebar upper end line L2. The dash-dot line L is one of lines for a division between a chamber upper portion 71a and a chamber lower portion 71b. The airbag 62 is deployed to a position below the handlebar 21.

Specifically, the airbag 62 has the connection portion 70 (see FIG. 3) connected to the inflator 63. The connection portion 70 is connected so as to cover the inflator 63 from the outer periphery, and is fixed to the retainer 61. The main chamber 71 is communicated with the connection portion 70. Thus, upon actuation of the inflator 63, the gas of the inflator 63 flows into the main chamber 71 through the connection portion 70.

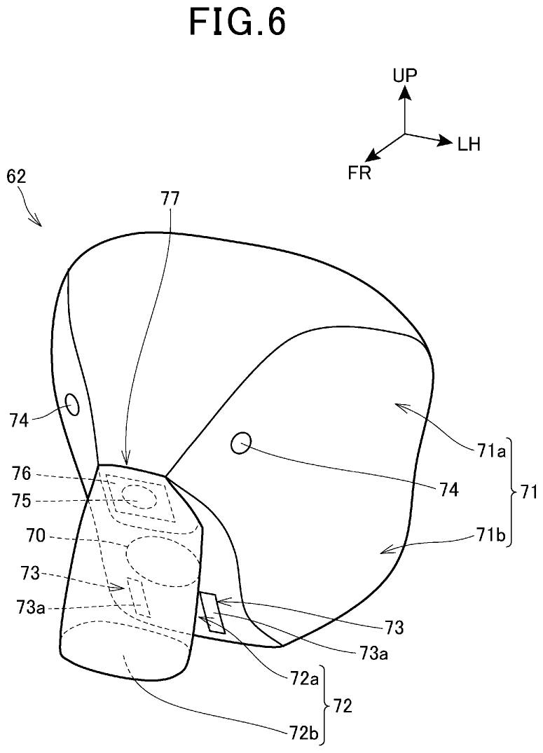

FIG. 6 is a perspective view of the airbag 62 after deployment as viewed from the front and left.

The main chamber 71 of the airbag 62 includes the chamber upper portion (upward deploying portion) 71a that bulges upward the handlebar 21 after deployment, and the chamber lower portion (downward deploying portion) 71b that bulges downward the handlebar 21 after deployment. The connection portion 70 is disposed between the chamber upper portion 71a and the chamber lower portion 71b. The connection portion 70 is disposed in a central portion in the vehicle width direction. The gas flows from the inflator 63 into the main chamber 71 through the connection portion 70. Thus, when the inflator 63 is actuated, the gas is configured to flow with ease into the chamber upper portion 71a and the chamber lower portion 71b approximately at the same time. Thus, stated another way, in FIG. 4, FIG. 8, the chamber upper portion 71a bulges further upward than a higher line L2 of the handlebar upper end line L2 and the dash-dot line L. Also, the chamber lower portion 71b bulges further downward than a lower line L1 of the handlebar upper end line L2 and the dash-dot line L.

In the chamber lower portion 71b, a perimeter reduction portion 73 extending in the vertical direction is disposed in a position to become the front face after deployment. The perimeter reduction portion 73 is a region deployed with a shorter perimeter in terms of appearance as compared with that in right and left adjacent regions (periphery). In other words, because, as a rule, the airbag 62 expands with gas, the airbag 62 enters into a condition of stretching outward from within, and enters easily into a curved surface condition in which the airbag is outwardly curved in a convex manner. Thus, in the airbag 62, the perimeter becomes a length following the shape outwardly curved in a convex manner. In contrast to this, in the perimeter reduction portion 73, as compared with the right and left adjacent regions of the perimeter reduction portion 73, deployment is performed with a shorter length in the perimeter direction (vertical direction). In other words, a difference between the perimeter of the right and left adjacent regions of the perimeter reduction portion 73 and the perimeter of the perimeter reduction portion 73 causes the airbag 62 to be deployed with creases formed on the periphery of the perimeter reduction portion 73.

For the perimeter reduction portion 73, in the embodiment, the top and bottom of the perimeter reduction portion 73 are sewn using a shorter tether (tether element) 73a as compared with the periphery. As a result, during deployment, the perimeter reduction portion 73 enters into a condition of imperfect deployment in the vertical direction, and is deployed with a shorter perimeter in the vertical direction as compared with the periphery. Instead of the tether 73a, the perimeter reduction portion 73 may be configured by a region sewn by placing basic fabric in the front-rear direction on top of the periphery.

A pair of right and left external ventholes 74 is disposed in the front face of the chamber upper portion 71a. The external venthole 74 is a hole for venting to the outside of the airbag 62. The external ventholes 74 facilitate the absorption of impact on the occupant R when the occupant R comes into contact with the airbag 62 after deployment of the airbag 62.

In the front face of the chamber upper portion 71a, an internal venthole 75 is formed below the external ventholes 74 and above the connection portion 70 (see FIG. 3, FIG. 6). The internal venthole 75 is formed in a central portion in the lateral direction. The internal venthole 75 is configured to facilitate escape of gas because of a lower pressure than the external ventholes 74. The sub-chamber 72 is connected around the internal venthole 75 to cover the internal venthole 75. The interior of the main chamber 71 is communicated with the interior of the sub-chamber 72 through the internal venthole 75.

The sub-chamber 72 is formed to expand in a bottomed cylinder shape. Specifically, the sub-chamber 72 has a cylindrical sub-chamber tube portion 72a that extends downward and forward from the front face of the chamber upper portion 71a, and a flat-shaped sub-chamber leading end portion 72b that is disposed to block the leading end of the sub-chamber tube portion 72a. Here, the outer surface of the sub-chamber tube portion 72a and the outer surface of the chamber upper portion 71a of the main chamber 71 are connected to form an angle smaller than 180 degrees. Stated another way, the outer surface of the sub-chamber tube portion 72a is connected to the outer surface of the chamber upper portion 71a to form a dent-shaped annular outer peripheral portion 77.

As illustrated in FIG. 4, for the sub-chamber 72, a size thereof and a connection position thereof after deployment are set such that, after deployment, the sub-chamber leading end portion 72b abuts on the display screen 55 of the meter 53, and the sub-chamber tube portion 72a abuts on the meter visor 57.

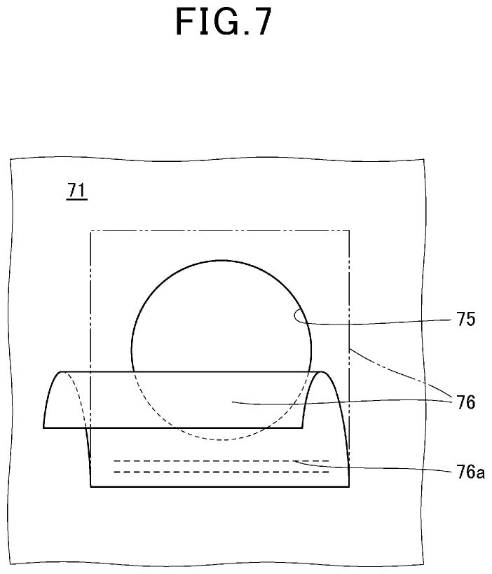

FIG. 7 is a diagram illustrating a main section of the airbag 62.

In the embodiment, the internal venthole 75 is blocked in an openable and closable manner by open/close base fabric (check valve member) 76 having flexibility. The open/close base fabric 76 has a size to cover the internal venthole 75. The open/close base fabric 76 is, for example, quadrangular in shape. The open/close base fabric 76 is arranged outside the main chamber 71. On a one side portion of the open/close base fabric 76, a sewing portion 76a for sewing the open/close base fabric 76 onto the main chamber 71 is formed along the one side of the open/close base fabric 76. Thereby, the open/close base fabric 76 extends along the outer surface of the main chamber 71 under normal conditions, and is held at a block position (the dash-dot-dot line of FIG. 7) for blocking the internal venthole 75. And, when gas is about to flow into the sub-chamber 72 from the main chamber 71, the sewing portion 76a serves as a base end so that the open/close base fabric 76 is pushed and deformed by the gas to move an open position (the solid line of FIG. 7). Thus, the internal venthole 75 is opened to allow the gas to flow into the sub-chamber 72. Also, if the gas is about to counterflow from the sub-chamber 72 to the main chamber 71, the open/close base fabric 76 restores to move to the block position. Thus, the internal venthole 75 is blocked to prevent backflow of the gas from the sub-chamber 72 to the main chamber 71. The open/close base fabric 76 functions as a check valve.

FIG. 8 is an explanatory diagram when the occupant R collides with the airbag 62 after deployment.

As illustrated in FIG. 1 to FIG. 8, in the saddle riding vehicle 10, upon sensing of collision, the inflator 63 is actuated to emit gas from the inflator 63. Upon emission of gas from the inflator 63, the airbag 62 is expanded by the gas to deploy toward the outside of the retainer 61. At this time, the lid 64 is pushed to cleave by the airbag 62, and the airbag 62 pushes away the remaining lid 64 to deploy.

Upon the gas flowing into the main chamber 71 of the airbag 62, the chamber upper portion 71a and the chamber lower portion 71b expand. At this time, as viewed from the side of the vehicle, the chamber upper portion 71a expands upward or forward with respect to the connection portion 70. Also, the chamber lower portion 71b expands downward or rearward with respect to the connection portion 70.

Here, because the perimeter reduction portion 73 is disposed in the chamber lower portion 71b, during deployment of the airbag 62, the airbag 62 deploys such that the base fabric around the perimeter reduction portion 73 is tensioned. Therefore, the leading end (rear end) of the front face (underside) of the chamber lower portion 71b is acted upon by a force to be pulled by the handlebar 21, so that the chamber lower portion 71b deploys in such a manner as to rotate downward and forward about the handlebar 21. Therefore, as illustrated in FIG. 4, FIG. 8, the chamber lower portion 71b deploys further downward than the handlebar upper end line L2 and the dash-dot line L, so that the chamber lower portion 71b is easily deployed to abut on the inner cover 42. Thus, the main chamber 71 readily enters into a condition of extending in the vertical direction, so that the chamber upper position 71a is easily positioned above the handlebar 21 and the chamber lower portion 71b is easily positioned below the handlebar 21. Specifically, the chamber upper portion 71a is positioned further upward than the handlebar upper end line L2 and the dash-dot line L and the chamber lower portion 71b has a part positioned further downward than the handlebar upper end line L2 and the dash-dot line L. In other words, the airbag 62 is deployed readily in a suitable posture for catching the occupant R.

In the chamber upper portion 71a, upon deployment by the inflow of gas, the gas escapes into the sub-chamber 72 through the internal venthole 75. The gas flowing out through the internal venthole 75 pushes away the open/close base fabric 76 to flow into the sub-chamber 72. Thus, the sub-chamber 72 bulges because of the gas to deploy toward a lower front portion. At this time, the sub-chamber leading end portion 72b abuts on the display screen 55 of the meter 53 or the meter cover 56. Also, the sub-chamber tube portion 72a abuts on the meter visor 57 in front. Thus, the chamber upper portion 71a of the main chamber 71 is supported by the meter 53 and the meter visor 57 via the sub-chamber 72.

Here, as illustrated in FIG. 8, upon contact of the occupant R with the airbag 62, in the chamber lower portion 71b of the airbag 62, the airbag 62 is caught against the inner cover 42. Also, in the chamber upper portion 71a, the airbag 62 is caught against the meter 53 and the meter visor 57 via the sub-chamber 72. Thus, the airbag 62 is applied with an appropriate reaction force from the front, so that it is made for the airbag 62 to catch the occupant R while the airbag 62 disposed in the handlebar 21 is maintained in appropriate posture.

In particular, the open/close base fabric 76 functioning as a check valve is disposed in the internal venthole 75. Thus, by preventing the backflow, after reduction in output of the inflator 63, a reduction in internal pressure in the sub-chamber 72 is easily inhibited, so that the chamber upper portion 71a is easily received appropriately by the meter 53 and the meter visor 57.

As described above, according to the embodiment to which the present invention is applied, a saddle riding vehicle includes: a steering system 31 that includes a handlebar 21; a meter 53 that is arranged in front of the handlebar 21, and is disposed at a level lower than the handlebar 21; and an airbag apparatus 60 that is disposed in the handlebar 21. In the saddle riding vehicle, the airbag apparatus 60 includes: an inflator 63; an airbag 62 that deploys with gas emitted by the inflator 63; and a retainer 61 that houses the airbag 62. The airbag 62 includes a sub-chamber 72 that bulges toward the meter 53 during deployment. With the configuration, in the saddle riding vehicle 10 including the airbag apparatus 60 in the handlebar 21, the posture of the airbag 62 during deployment may be stabilized. Thus, the impact acting on the occupant R may be effectively lessened.

In the embodiment, the airbag 62 includes: a main chamber 71 that deploys upward and downward the handlebar 21 at the rear of the handlebar 21; and the sub-chamber 72 that protrudes downward and forward with respect to the main chamber 71 and deploys from above the handlebar 21.

With the configuration, because the sub-chamber 72 is shaped to protrude downward and forward from the main chamber 71, the sub-chamber 72 is easily deployed to butt against the meter 53, so that the reaction force from the meter 53 may be received via the sub-chamber 72 during deployment. Thus, the posture of the airbag 62 may be stabilized.

Further, in the embodiment, a meter visor 57 that covers the meter 53 from the front is included. The sub-chamber 72 abuts on the meter visor 57 during deployment.

With the configuration, the sub-chamber 72 abuts on the meter visor 57, so that, when the occupant R comes into contact with the airbag 62, the sub-chamber 72 is easily inhibited from moving forward beyond the meter 53. Therefore, the airbag 62 may be deployed under conditions of stable posture.

Further, in the embodiment, the main chamber 71 includes: an chamber upper portion 71a that deploys upward the handlebar 21; and a chamber lower portion 71b that deploys downward the handlebar 21. The chamber lower portion 71b is provided with a perimeter reduction portion 73 that deploys with a shorter perimeter in the vertical direction than that of right and left peripheries.

With the configuration, during deployment of the main chamber 71, the front face of the chamber lower portion 71b is easily acted upon by a force pulled toward the handlebar 21 by the perimeter reduction portion 73, so that the chamber lower portion 71b may be acted upon by a force of forward rotational movement around the handlebar 21. Thus, the chamber lower portion 71b may be inhibited from rotationally moving rearward.

Further, in the embodiment, a tether 73a is included to join upper and lower ends of the perimeter reduction portion 73. With the configuration, the perimeter reduction portion 73 may be realized by a simple configuration using the tether 73a for connection on the surface of the airbag 62.

Further, in the embodiment, between the main chamber 71 and the sub-chamber 72, an open/close base fabric 76 is disposed to restrict backflow of gas from the sub-chamber 72 to the main chamber 71.

With the configuration, the internal pressure in the sub-chamber 72 during deployment is easily maintained, so that an appropriate reaction force may be easily received from the meter 53.

Further, in the embodiment, the airbag 62 has a right-left width larger than that of a meter cover 56 covering the meter 53, and also the right-left width is smaller than a length between outer ends in the vehicle width direction of right and left grips 37a, 37b. In particular, in the embodiment, the airbag 62 is narrower than a length between inner ends in the vehicle width direction of the right and left grips 37a, 37b.

With the configuration, the airbag 62 is easily made compact, so that the airbag apparatus 60 may be made compact. Thus, the airbag apparatus 60 may be easily disposed in the handlebar 21.

Further, in the embodiment, a handlebar post 34 is included, and the handlebar post 34 is disposed at an upper end portion of the steering system 31 to support the handlebar 21. The handlebar post 34 has an insertion hole 34a formed therein to penetrate in the vertical direction. The airbag apparatus 60 includes: a hook portion 65 that is hooked on the handlebar 21; and an insertion portion 66 that is inserted and attached into the insertion hole 34a.

With the configuration, the airbag apparatus 60 disposed in the saddle riding vehicle 10 may be easily attached.

Further, in the embodiment, an inner cover 42 that covers the steering system 31 from behind is included. The airbag 62 is received at the inner cover 42 and the handlebar 21.

With the configuration, an appropriate reaction force may be easily received from the inner cover 42 during deployment.

### Other Embodiments

The above embodiment merely illustrates an aspect of the present invention, and various variations and applications are optionally possible without departing from the sprit and scope of the present invention.

In the above embodiment, the configuration has been described in which the sub-chamber 72 abuts on the meter visor 57 but does not abut on the front face of the handlebar 21. However, a configuration of the sub-chamber 72 is not limited to this. For example, the sub-chamber 72 may be configured to be sized based on the front-rear length between the meter visor 57 and the handlebar 21. At this time, for example, the sub-chamber 72 may be made easy to abut on the handlebar 21 such as by displacing the position of the retainer 61 rearward with respect to the handlebar 21, and the like. This makes it easy for the sub-chamber 72 to abut on the front face of the handlebar 21 during deployment. At this time, the sub-chamber 72 deploying easily enters into a condition of being sandwiched between the meter visor 57 and the handlebar 21 extending in the lateral direction, so that the position of the airbag 62 may be easily stabilized during deployment.

In the above embodiment, a motorcycle that has the front wheel 13 and the rear wheel 15 has been described as the saddle riding vehicle 10 by way of example, but the present invention is not limited to this. The present invention may be applied to a three-wheeled saddle riding vehicle having two front or rear wheels, a saddle riding vehicle having four or more wheels.

### [Configurations Supported by the Above-Described Embodiment]

The above-described embodiment supports the following configurations.

### (Configuration 1)

A saddle riding vehicle includes: a steering system that includes a handlebar; a meter that is arranged in front of the handlebar, and is disposed at a level lower than the handlebar; and an airbag apparatus that is disposed in the handlebar. In the saddle riding vehicle, the airbag apparatus includes: an inflator; an airbag that deploys with gas emitted by the inflator; and a retainer that houses the airbag, and the airbag includes a bulge portion that bulges toward the meter during deployment.

With the configuration, in the saddle riding vehicle including the airbag apparatus in the handlebar, the posture of the airbag during deployment may be stabilized.

### (Configuration 2)

In the saddle riding vehicle according to the configuration 1, the airbag includes: an airbag main body that deploys upward and downward the handlebar at the rear of the handlebar; and the bulge portion that protrudes downward and forward with respect to the airbag main body and deploys from above the handlebar.

With the configuration, because the bulge portion is shaped to protrude downward and forward from the airbag main body, the bulge portion is easily deployed to butt against the meter, so that the reaction force from the meter may be received via the bulge portion during deployment. Thus, the posture of the airbag may be stabilized.

### (Configuration 3)

In the saddle riding vehicle according to the configuration 2, the saddle riding vehicle further includes a meter visor that covers the meter from the front, and the bulge portion abuts on the meter visor during deployment.

With the configuration, the bulge portion abuts on the meter visor, so that, when the occupant comes into contact with the airbag, the bulge portion is easily inhibited from moving forward beyond the meter. Therefore, the airbag may be deployed under conditions of stable posture.

### (Configuration 4)

In the saddle riding vehicle according to the configuration 3, the bulge portion abuts on a front face of the handlebar during deployment.

With the configuration, because the bulge portion is easily sandwiched between the meter visor and the handlebar, the position of the bulge portion may be easily stabilized, and therefore the airbag may be stably deployed.

### (Configuration 5)

In the saddle riding vehicle according to any one of the configurations 2 to 4, the airbag main body includes: an upward deploying portion that deploys upward the handlebar; and a downward deploying portion that deploys downward the handlebar, and the downward deploying portion is provided with a perimeter reduction portion that deploys with a shorter perimeter in a vertical direction than that of right and left peripheries.

With the configuration, during deployment of the airbag main body, the front face of the downward deploying portion is easily acted upon by a force pulled toward the handlebar by the perimeter reduction portion, so that the downward deploying portion may be acted upon by a force of forward rotational movement around the handlebar. Thus, the downward deploying portion may be inhibited from rotationally moving rearward.

### (Configuration 6)

In the saddle riding vehicle according to the configuration 5, the saddle riding vehicle further includes a tether element that joins upper and lower ends of the perimeter reduction portion.

With the configuration, the perimeter reduction portion may be realized by a simple configuration using the tether element for connection on the surface of the airbag.

### (Configuration 7)

In the saddle riding vehicle according to any one of the configurations 2 to 6, the saddle riding vehicle further includes a check valve member that restricts backflow of gas from the bulge portion to the airbag main body, the check valve member being disposed between the airbag main body and the bulge portion.

With the configuration, the internal pressure in the bulge portion during deployment is easily maintained, so that an appropriate reaction force may be easily received from the meter.

### (Configuration 8)

In the saddle riding vehicle according to any one of the configurations 1 to 7, the airbag has a right-left width larger than that of a meter cover covering the meter, and also has the right-left width smaller than a length between right and left grips.

With the configuration, the airbag is easily made compact, so that the airbag apparatus may be made compact. Thus, the airbag apparatus may be easily disposed in the handlebar.

### (Configuration 9)

In the saddle riding vehicle according to any one of the configurations 1 to 8, the saddle riding vehicle further includes a support member that is disposed at an upper end portion of the steering system to support the handlebar, the support member has an insertion hole formed therein to penetrate in the vertical direction, and the airbag apparatus includes: a hook portion that is hooked on the handlebar; and an insertion portion that is inserted and attached into the insertion hole.

With the configuration, the airbag apparatus disposed in the saddle riding vehicle may be easily attached.

### (Configuration 10)

In the saddle riding vehicle according to any one of the configurations 1 to 9, the saddle riding vehicle further includes an inner cover that covers the steering system from behind, and the airbag is received at the inner cover and the handlebar.

With the configuration, an appropriate reaction force may be easily received from the inner cover during deployment.

### REFERENCE SIGNS LIST

10 Saddle riding vehicle
21 Handlebar
31 Steering system
34 Handlebar post (support member)
34a Insertion hole
37a Grip
37b Grip
42 Inner cover
53 Meter
56 Meter cover
57 Meter visor
60 Airbag apparatus
61 Retainer
62 Airbag
63 Inflator
65 Hook portion
66 Insertion portion
71 Main chamber (airbag main body)
71a Chamber upper portion (upward deploying portion)
71b Chamber lower portion (downward deploying portion)
72 Sub-chamber (bulge portion)
73 Perimeter reduction portion
73a Tether (tether element)
76 Open/close base fabric (check valve member)

1. A saddle riding vehicle, comprising: a steering system that includes a handlebar; a meter that is arranged in front of the handlebar, and is disposed at a level lower than the handlebar; and an airbag apparatus that is disposed in the handlebar, wherein
the airbag apparatus includes: an inflator; an airbag that deploys with gas emitted by the inflator; and a retainer that houses the airbag, and
the airbag includes a bulge portion that bulges toward the meter during deployment.

2. The saddle riding vehicle according to claim 1, wherein
the airbag includes: an airbag main body that deploys upward and downward the handlebar at the rear of the handlebar; and the bulge portion that protrudes downward and forward with respect to the airbag main body and deploys from above the handlebar.

3. The saddle riding vehicle according to claim 2, further comprising a meter visor that covers the meter from the front, wherein
the bulge portion abuts on the meter visor during deployment.

4. The saddle riding vehicle according to claim 3, wherein
the bulge portion abuts on a front face of the handlebar during deployment.

5. The saddle riding vehicle according to claim 2, wherein
the airbag main body includes: an upward deploying portion that deploys upward the handlebar; and a downward deploying portion that deploys downward the handlebar, and
the downward deploying portion is provided with a perimeter reduction portion that deploys with a shorter perimeter in a vertical direction than that of right and left peripheries.

6. The saddle riding vehicle according to claim 5, further comprising a tether element that joins upper and lower ends of the perimeter reduction portion.

7. The saddle riding vehicle according to claim 2, further comprising a check valve member that restricts backflow of gas from the bulge portion to the airbag main body, the check valve member being disposed between the airbag main body and the bulge portion.

8. The saddle riding vehicle according to claim 1, wherein
the airbag has a right-left width larger than that of a meter cover covering the meter, and also has the right-left width smaller than a length between right and left grips.

9. The saddle riding vehicle according to claim 1, further comprising a support member that is disposed at an upper end portion of the steering system to support the handlebar, wherein
the support member has an insertion hole formed therein to penetrate in the vertical direction, and
the airbag apparatus includes: a hook portion that is hooked on the handlebar; and an insertion portion that is inserted and attached into the insertion hole.

10. The saddle riding vehicle according to claim 1, further comprising an inner cover that covers the steering system from behind, wherein
the airbag is received at the inner cover and the handlebar.
